(19) United States
(12) Patent Application Publication
(10) Pub. No.: US 2007/0114926 A1
(43) Pub. Date: May 24, 2007

(54) Image display device

(76) Inventors: Yuuichi Kijima, Chosei (JP); Yoshiyuki Kaneko, Hichioji (JP); Kenji Kato, Mobara (JP); Noriyuki Oroku, Yokohama (JP); Toshio Sasamoto, Hamura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/589,797

(22) Filed: Oct. 31, 2006

(30) Foreign Application Priority Data
Oct. 31, 2005 (JP) 2005-316290

(51) Int. Cl. H01J 63/04; H01J 1/62

(52) U.S. Cl. 313/512; 313/497

(57) ABSTRACT

An image display device is constituted such that a back substrate on which image signal lines, scanning signal lines and electron sources are arranged and a face substrate which has phosphor layers are hermetically sealed to each other by way of a frame body using a sealing material, and the inside of the image display device is formed into a vacuum. A length LSK of a second sealing region into which scanning signal lines hermetically penetrate is set larger than a length LDK of a first sealing region into which thin-film image signal lines hermetically penetrate and hence, it is possible to suppress the decrease of the degree of vacuum.

### BACKGROUND OF THE INVENTION

1. Field of the Invention

The present invention relates to a planar image display device which makes use of emission of electrons into vacuum formed between a face substrate and a back substrate.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar image display device (flat panel display, FPD) which is light-weighted and requires a small space for installation while ensuring the excellent properties such as high brightness and high definition.

As typical examples of such a planar image display device, a liquid crystal display device, a plasma display device or the like has been put into practice. Further, particularly with respect to the planar display device which can realize the high brightness, with respect to a self luminous display device which makes use of emission of electrons into vacuum from electron sources, various planar image display devices such as an electron emitting type image display device, a field emitting type image display device, an organic EL display which is characterized by low power consumption and the like are expected to be put into practice in near future.

Among these planar image display devices, with respect to the self-luminous flat panel display, there has been known a display device having the constitution in which electron sources are arranged in a matrix array, wherein as one such display, there has been also known the above-mentioned electron emitting type image display device which makes use of minute and integrative cold cathodes.

Further, in the self-luminous flat panel display, as cold cathodes, thin film electron sources of a spindle type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor layer-metal or the like has been used.

With respect to the MIM type electron source, for example, there has been known an electron source which is disclosed in Japanese Patent Laid-open Hei7(1995)-65710 (patent document 1) and Japanese Patent Laid-open Hei10(1998)-153979 (patent document 2), for example. Further, with respect to the metal-insulator-semiconductor electron source, there has been known an MOS type electron source reported inj. Vac. Sci. Technol. B11 (2) p. 429-432 (1993) (non-patent document 1). Further, with respect to the metal-insulator-semiconductor-metal type electron source, there has been known a HEED type electron source reported in high-efficiency-electro-emitting device, Jpn. J. Appl. Phys., vol 36, pL 939 (non-patent document 2), an EL type electron source reported in Electroluminescence, Applied Physics, Volume 63, No. 6, p. 592 (non-patent document 3), or a porous silicon type electron source reported in Applied Physics, Volume 66, No. 5, p. 437 (non-patent document 4).

As the electron emitting type FPD, there has been known a display panel which includes a back substrate having the above-mentioned electron sources, a face substrate which includes phosphor layers and anodes which form accelerating electrodes for allowing electrons emitted from the electron sources to impinge on the phosphor layers and is arranged to face the back substrate, and a frame body which forms a sealing frame for creating a predetermined vacuum state in an inner space defined between both substrates which face each other. The display device is operated by combining a drive circuit to the display panel.

The electron emitting type image display device includes a back substrate which forms, on the back substrate thereof, a large number of first lines (for example, referred to as cathode lines, video signal lines) which extend in the first direction and are arranged in parallel in the second direction which intersects the first direction, an insulation film which is formed in a state that the insulation film covers the first lines, a large number of second lines (for example, referred to as gate lines, scanning signal lines) which extend in the second direction and are arranged in parallel in the first direction over the insulation film, and electron sources which are provided in the vicinity of intersecting portions of the first lines and the second lines. The back substrate includes a substrate made of an insulating material and the above-mentioned lines are formed on the substrate.

In such a constitution, a scanning signal is sequentially applied to the scanning signal lines. Further, on the substrate, the above-mentioned electron source is provided in a state that the electron source is connected to the scanning signal line and the image signal line. The respective lines and the respective electrodes which constitute the electron sources are connected with each other using a power supply electrode so that an electric current is supplied to the electron sources. A face substrate is arranged to face the back substrate in an opposed manner, wherein phosphor layers of plural colors and the anode are formed on an inner surface of the face substrate which faces the back substrate in an opposed manner. The face substrate is made of alight-transmitting material which is preferably glass. Further, both substrates are sealed by inserting a support body which constitutes a sealing frame between laminating inner peripheries of both substrates, and the inside which is formed by the back substrate, the face substrate and the support body is evacuated thus constituting the image display device.

The electron source is positioned at the intersecting portion of the first line and the second line as mentioned above. An emission quantity of electrons from the electron source (including the turning on and off of the emission) is controlled based on a potential difference between the first line and the second line. The emitted electrons are accelerated due to a high voltage applied to the anode formed on the face substrate, and impinge on phosphor layers formed on the face substrate thus exciting the phosphor layers and the light of colors corresponding to lights emitting characteristics of the phosphor layers are generated.

The individual electron source forms a pair with a corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In the planner image display device described above, in general, in the inside of a display region which is arranged between the back substrate and the face substrate and is surrounded by the frame body, a plurality of distance holding members (hereinafter referred to as spacers) are arranged and fixed. The distance between the above-mentioned both substrates is held at a predetermined distance in cooperation with the frame body. The spacers are formed of a plate-like body which is made of an insulating material such as glass, ceramics or the like, in general. Usually, the spacers are arranged at positions which do not impede an operation of pixels for every plurality of pixels.

Further, the frame body which constitutes a sealing frame is fixed to inner peripheries of the back substrate and the face substrate using a sealing material such as frit glass, and the fixing portions are hermetically sealed thus forming sealing regions. The degree of vacuum in the inside of a display region defined by both substrates and the frame body is set to 10⁻⁵ to 10⁻⁷ Torr, for example.

The first lines and the second lines which are formed on the back substrate penetrate the sealing regions defined by the frame body and the substrates, and proximal portions of the first and second lines include first line lead terminals and second line lead terminals respectively.

Usually, the frame body which constitutes the sealing frame is fixed to the back substrate and the face substrate using the sealing material such as frit glass or the like.

Further, Japanese Patent Laid-open Hei9(1997)-277586 (patent document 3) discloses an image forming device which includes the structure in which a takeout portion of an electrode line to the outside is bent below a support frame.

### SUMMARY OF THE INVENTION

The first lines and the second lines are arranged on a back substrate, and these lines penetrate a region where a surface of the back substrate and an end surface of the frame body are opposed to each other and are extend to the outside. In the region, a sealing material such as a flit glass or the like is arranged so as to constitute a sealing region. In such a constitution, to obtain a display image having a predetermined brightness, it is necessary to allow a large quantity of current flow into scanning lines compared to video signal lines. According to such a large quantity of flow of the current, there arises a drawback that a voltage drop is generated along the scanning signal lines.

To lower the voltage drop, it is necessary to decrease the electric resistance of the scanning signal line. Although the scanning signal electrode is formed of a thin film made of a metal material such as Al (aluminum), for example, to reduce the electric resistance, it is necessary to increase a film thickness of the metal thin film which constitutes the line (to make the film thickness of the metal thin film thick). However, when the film thickness is increased, a stress in the line is increased thus giving rise to a drawback that the line is easily peeled off from the back substrate. This drawback also arises with respect to the constitution described in the above-mentioned patent document 1.

Further, since the image signal line and the scanning signal line differ from each other with respect to a value of a current flow which flows in such lines and hence, these signal lines differ from each other in film thickness. The thick film portion is liable to easily generate vacuum leaking compared to the thin film portion. The generation of the vacuum leaking brings about the degradation of degree of vacuum in a vacuum display region thus damaging the reliability of the image display device.

Further, provided that there is no possibility of generation of the vacuum leaking, the smaller a width of the sealing region, the generation of drawbacks attributed to the flow of the sealing material is decreased and hence, the narrowing of the width of the sealing region is desirable.

It is an object of the present invention to provide a highly reliable image display device which can prevent leaking of vacuum from being generated in a sealing region and can possess a prolonged lifetime.

To achieve the above-mentioned object, according to the present invention, a width of the sealing region is configured to correspond to a film thickness of lines which penetrate the sealing region.

An image display device includes a back substrate which includes a plurality of first lines which extend in the first direction and are arranged in parallel in the second direction which intersects the first direction, an insulation film which is formed in a state that the insulation film covers the first lines, a plurality of second lines which extend in the second direction and are arranged in parallel in the first direction over the insulation film, and electron sources which are provided in the vicinity of intersecting portions of the first electrodes and the second electrodes and are connected to the first lines and the second lines, a face substrate which includes phosphor layers of a plurality of colors which emit light due to excitation thereof by electrons emitted from the electron sources of the back substrate and an anode, the face substrate facing the back substrate with a predetermined distance therebetween, a frame body which is interposed between the back substrate and the face substrate so as to surround a display region and holds the predetermined distance, and a panel which includes a sealing material which hermetically seals end surfaces of the frame body to the face substrate and the back substrate respectively and evacuate air in a space surrounded by the back substrate, the face substrate and the frame body. The image display device includes a first sealing region in which a sealing material which extends in the second direction is arranged on the plurality of first lines and a second region in which a sealing material which extends in the first direction is arranged on the plurality of second lines, and a first-direction width of the first sealing region and a second-direction width of the second sealing region differ from each other.

Into the image display panel having the above-mentioned constitution, an image signal drive circuit, a scanning signal drive circuit and the other peripheral circuits are assembled thus constituting a self-luminous flat panel display device.

According to the present invention, the generation of leaking of vacuum is prevented by changing a line-penetrating-direction length in the sealing region due to thick-film lines and thin-film lines thus obtaining the highly reliable image display device which can possess a prolonged lifetime.

Further, by controlling a quantity of a sealing material to be used, a flow of the sealing material into a portion at which the sealing material is unnecessary can be suppressed thus enhancing the operability and ensuring the display quality.

At a portion of the sealing region formed between the frame body and the back substrate, a length of a sealing region portion arranged inside the panel differs from a length of the sealing region portion arranged outside the panel. By setting the line-penetrating-direction length of an evacuated region side (inside) of the sealing region larger than the line-penetrating-direction length of an atmospheric pressure side of the sealing region, it is possible to ensure an engaging space between a terminal and an external circuit and, at the same time, it is possible to prevent the leaking of vacuum from being generated thus obtaining the highly reliable image display device which can possess a prolonged lifetime.

The first lines and the second lines differ from each other in thickness inside the sealing region and hence, it is possible to select a size of the sealing region corresponding to a line film thickness and thus obtaining the highly reliable image display device which can prevent the leaking of vacuum from being generated and can possess a prolonged lifetime.

At least either one of the first lines and the second lines have line portions thereof which are arranged inside the panel and in the sealing region formed into the stacked structure and hence, it is possible to realize thick film lines easily thus enhancing the electrical characteristic inside the vacuum display region and realizing the acquisition of an inexpensive image display device.

The stacked structure includes a combination of materials which differ from each other in conductivity and hence, it is possible to ensure the electrical characteristic and to prevent the leaking of vacuum from being generated thus obtaining the highly reliable image display device which can possess a prolonged lifetime.

The first lines are video signal lines and hence, it is possible to select the size of the sealing region corresponding to the line thickness whereby the generation of drawbacks attributed to the flow of the sealing material can be prevented thus ensuring the electrical characteristic and obtaining the highly reliable image display device which can possess a prolonged lifetime.

The second lines are scanning signal lines and hence, the line thickness of the scanning lines is larger than the line thickness of the video signal lines whereby advantageous effects obtained by such a constitution become remarkable. Accordingly, it is possible to prevent the leaking of vacuum from being generated in the sealing region thus obtaining the highly reliable image display device which can possess a prolonged lifetime.

### BRIEF EXPLANATION OF DRAWINGS

FIG. 1A is a plan view of an image display device of the present invention as viewed from a face substrate side, and FIG. 1B is a side view of the image display device shown in FIG. 1A;

FIG. 2 is a schematic plan view of the image display device taken along a line A-A in FIG. 1A;

FIG. 3 is a schematic cross-sectional view of a back substrate taken along a line B-B in FIG. 2 and a schematic cross-sectional view of a portion of the face substrate which corresponds to the back substrate;

FIG. 4 is a schematic cross-sectional view of a back substrate taken along a line C-C in FIG. 2 and a schematic cross-sectional view of a portion of the face substrate which corresponds to the back substrate;

FIG. 5 is a schematic cross-sectional view of a back substrate taken along a line D-D in FIG. 2 and a schematic cross-sectional view of a portion of the face substrate corresponding to the back substrate;

FIG. 6 is a schematic cross-sectional view of another embodiment of the image display device of the present invention corresponding to FIG. 4;

FIG. 7 is a schematic cross-sectional view of further another embodiment of the image display device of the present invention corresponding to FIG. 3;

FIG. 8 is a schematic cross-sectional view of further another embodiment of the image display device of the present invention corresponding to FIG. 3;

FIG. 9 is a schematic cross-sectional view taken along a line E-E in FIG. 8;

FIG. 10A, FIG. 10B and FIG. 10C are views for explaining an example of electron sources which constitute pixels of the image display device of the present invention, wherein FIG. 10A is a plan view, FIG. 10B is a cross-sectional view taken along a line E-E in FIG. 10A, and FIG. 10C is a cross-sectional view taken along a line F-F in FIG. 10A; and

FIG. 11 is an explanatory view of an equivalent circuit example of the image display device to which the constitution of the present invention is applied.

### DESCRIPTION OF THE PREFERRED EMBODIMENTS

Hereinafter, embodiments of the present invention are explained in detail in conjunction with drawings.

### Embodiment 1

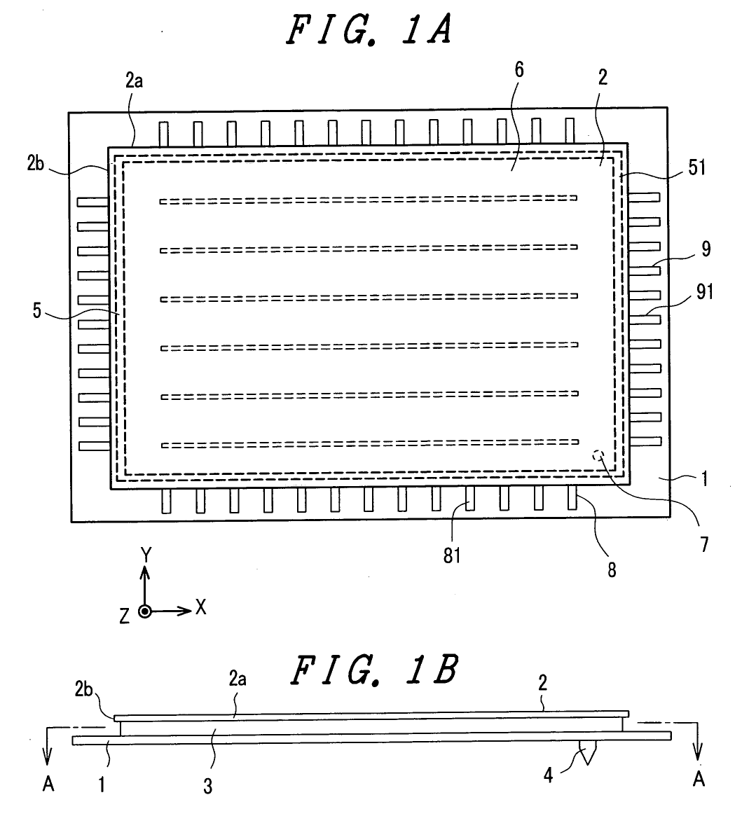

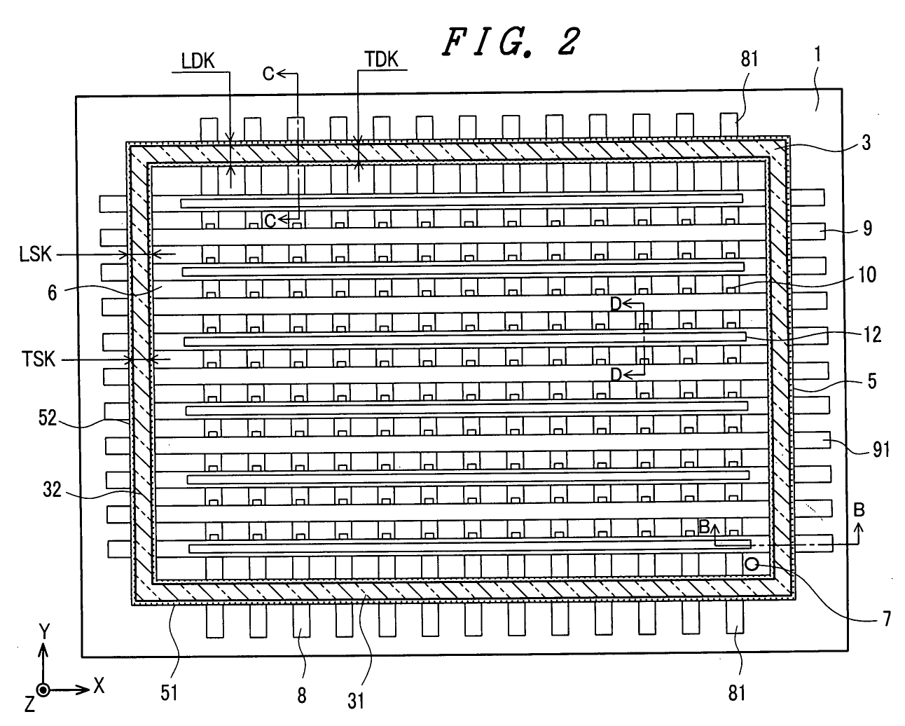

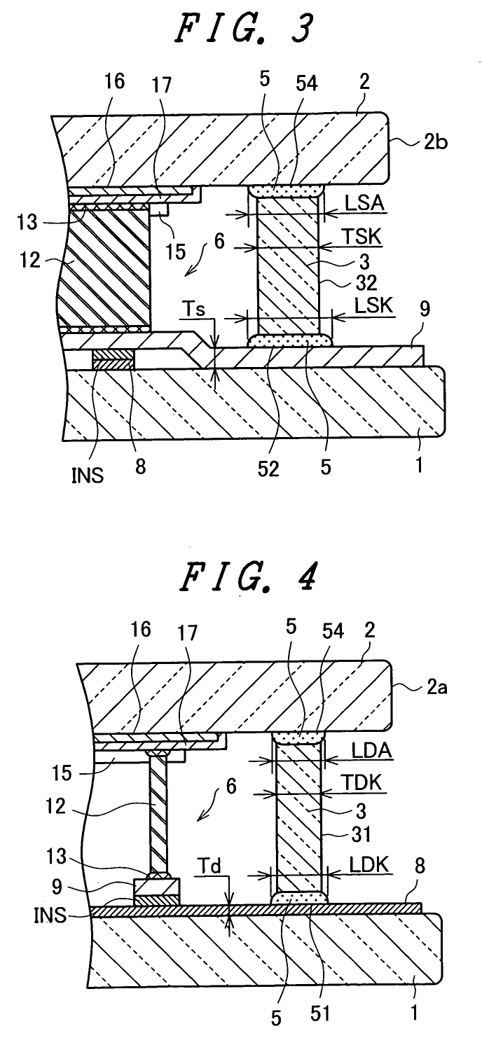

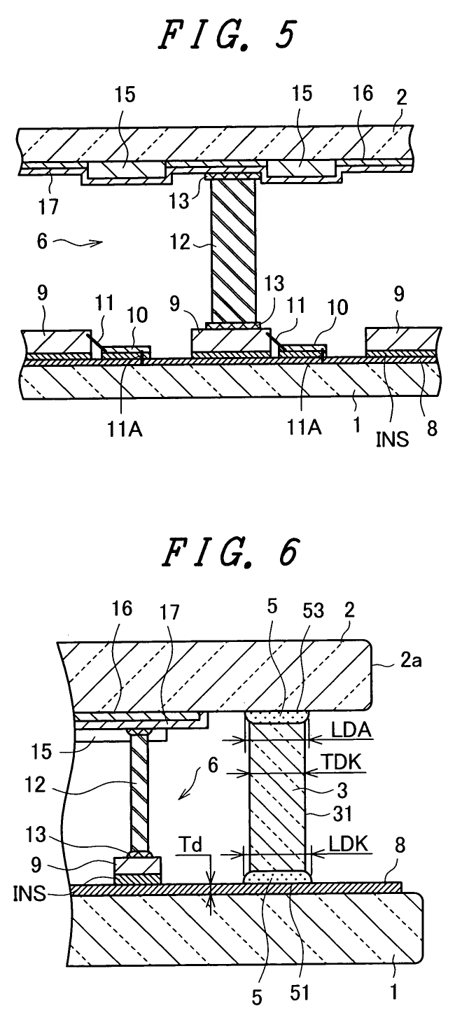

FIG. 1A to FIG. 5 are views for explaining one embodiment of an image display device according to the present invention. FIG. 1A is a plan view as viewed from a face substrate side, FIG. 1B is a side view of FIG. 1A, FIG. 2 is a schematic plan view taken along a line A-A in FIG. 1B, FIG. 3 is a schematic cross-sectional view of a back substrate taken along a line B-B in FIG. 2 and a schematic cross-sectional view of a portion of the face substrate which corresponds to the back substrate, FIG. 4 is a schematic cross-sectional view of a back substrate taken along a line C-C in FIG. 2 and a schematic cross-sectional view of a portion of the face substrate which corresponds to the back substrate, and FIG. 5 is a schematic cross-sectional view of a back substrate taken along a line D-D in FIG. 2 and a schematic cross-sectional view of a portion of the face substrate corresponding to the back substrate.

In these FIG. 1A to FIG. 5, numeral 1 indicates a back substrate and numeral 2 indicates a face substrate, wherein both substrates 1, 2 are formed of a glass plate having a thickness of several mm, for example, approximately 1 to 10 mm. Both substrates are formed in a substantially rectangular shape. The back substrate and the face substrate are stacked with a predetermined distance therebetween.

Numeral 3 indicates a frame body. The frame body 3 is formed of, for example, a frit glass sintered body, a glass plate or the like. The frame body 3 is formed by a single body or by a combination of a plurality of members and is formed in a substantially rectangular shape. Further, the frame body 3 is interposed between the above-mentioned both substrates 1, 2.

The frame body 3 is constituted by combining a pair of frame body members 31 which are arranged on long sides of the approximately rectangular shape and a pair of frame body members 32 which are arranged on short sides of the approximately rectangular shape. Further, the frame body members 31, 32 differ from each other in thickness. That is, a thickness TDK of the frame body member 31 and a thickness TDK of the frame body member 32 differ from each other. The frame body 3 is interposed between peripheral portions of both substrates 1, 2 and is hermetically adhered to the peripheral portions of both substrates 1, 2. On the other hand, a height of the frame body is set to a size substantially equal to a distance between both substrates 1, 2.

Numeral 4 indicates an exhaust pipe. The exhaust pipe 4 is fixedly mounted on the back substrate 1. Further, numeral 5 indicates a sealing material. The sealing material 5 is made of frit glass, for example, and joins the frame body 3 and both substrates 1, 2 thus hermetically sealing the space defined by the frame body 3 and both substrates 1, 2.

The space 6 which is surrounded by the frame body 3, both substrates 1, 2 and the sealing material 5 is evacuated through the exhaust pipe 4 holding a degree of vacuum of, for example, 10⁻⁵ to 10⁻⁷ Torr. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed.

Numeral 8 indicates video signal lines and these video signal lines 8 extend in one direction (Y direction) with a thickness of Td and are arranged in parallel in another direction (X direction) on an inner surface of the back substrate 1. These video signal lines 8 hermetically penetrate a first sealing region 51 between the frame body member 31 of the frame body 3 and the back substrate 1 from the space 6 and further extend outwardly from along-side side outer end 2a of the face substrate 2 stacked on the back substrate 1 at an edge portion of the long-side side of the back substrate 1. Further, the video signal lines 8 has a distal end portions thereof formed into video signal line lead terminals 81. Here, a length LDK indicates a length of the penetrating direction.

Numeral 9 indicates scanning signal lines. The scanning signal lines 9 extend over the video signal lines 8 in the above-mentioned another direction (X direction) which intersects the video signal lines 8 with a thickness of Ts (Ts>Td) and are arranged in parallel in the above-mentioned one direction (Y direction). These scanning signal lines 9 hermetically penetrate a second sealing region 52 having a length LDK of a hermetically sealed portion between the frame body member 32 of the frame body 3 and the back substrate 1 from the space 6 and further extend outwardly from a short-side side outer end 2b of the face substrate 2 stacked on the back substrate 1 at an edge portion of the short-side side of the back substrate 1. Further, distal end portions of the scanning signal lines 9 constitute scanning signal line lead terminals 91.

Further, a relationship LSK>LDK is established between the penetrating direction length (sealing width) LSK of the second sealing region 52 and the penetrating direction length (sealing width) LDK of the first sealing region 51.

In the relationship LSK>LDK, the scanning signal lines 9 have the film thickness Ts larger than the film thickness Td of the video signal lines 8 (Ts>Td). By taking this difference in film thickness into consideration, the penetrating direction length LSK of the second sealing region 52 into which the scanning signal lines 9 hermetically penetrate is greater (wider) than the penetrating direction length LDK of the first sealing region 51 into which the video signal lines 8 hermetically penetrate.

Numeral 10 indicates electron sources and the electron sources 10 are formed in the vicinity of respective intersecting portions of the scanning signal lines 9 and the video signal lines 8. The electron sources 10 are connected with the scanning signal lines 9 and the video signal lines 8 via connection lines 11, 11A respectively. Further, interlayer insulation films INS are arranged between the video signal lines 8, the electron sources 10 and the scanning signal lines 9.

Here, the video signal lines 8 are formed of an Al (aluminum) film, for example, while the scanning signal lines 9 are formed of a Cr/Al/Cr film, a Cr/Cu/Cr film or the like, for example. Further, although the above-mentioned line lead terminals 81, 91 are provided to both ends of the electrodes, the line lead terminals 81, 91 may be provided to only either one of these ends.

Next, numeral 12 indicates spacers, wherein the spacers 12 are made of a ceramic material and are shaped in a rectangular thin plate shape. The spacers 12 are arranged above the scanning signal lines 9 every one other line substantially parallel to the frame body 3 in an elected manner, and are fixed to both substrates 1, 2 using an adhesive material 13. The fixing of the spacers 12 to the substrates using the adhesive material 13 may be applied to only one end side of the spacers 12. Further, with respect to the arrangement of the spacers 12, the spacers 12 are usually arranged at positions at which the spacers 12 do not impede the operations of the pixels for every plurality of other pixels.

Sizes of the spacers 12 are set based on sizes of substrates, a height of the frame body 3, materials of the substrates, an arrangement interval of the spacers, a material of spacers and the like. In general, the height of the spacers is approximately equal to a height of the frame body 3. A thickness of the spacer 12 is set to several 10 μm to several mm or less, while a length is set to approximately 20 mm to 1000 mm. Preferably, a practical value of the length is approximately 80 mm to 120 mm. Further, the spacers 12 possess a resistance value of approximately 10⁸ to 10⁹Ω·cm.

In an inner surface of the face substrate 2 to which one end sides of the spaces 12 are fixed, phosphor layers 15 of red, green and blue are arranged in a state that these phosphor layers 15 are defined by a light-blocking BM (black matrix) film 16. A metal back (an anode electrode) 17 made of a metal thin film is formed in a state that the metal back 17 covers the phosphor layers 15 and the BM film 16 by a vapor deposition method thus forming a phosphor screen.

Further, with respect to these phosphor layers 15, for example, Y₂O₂S:Eu(P22-R) may be used as the red phosphor, ZnS:Cu,Al(P22-G) may be used as the green phosphor, and ZnS:Ag,Cl(P22-B) may be used as the blue phosphor. With such phosphor screen constitution, electrons irradiated from the above-mentioned electron source 10 are accelerated and impinge on the phosphor layers 15 which constitute the corresponding pixels. Accordingly, the phosphor layer 15 emits light of the given color and the light is mixed with an emitted light of color of the phosphor of another pixel thus constituting the color pixel of a given color. Here, a region in which the phosphors emit light whereby the image is displayed is the display region. Further, the anode electrode 17 is indicated as a face electrode, the anode electrodes 17 can be formed of stripe-like electrodes which are divided for every pixel column while intersecting the scanning signal lines 9.

The face substrate 2 which includes the phosphor surface and the frame body 3 are hermetically sealed by way of the sealing material 5 over the whole periphery of the frame body 3 which is formed in a frame shape.

The above-mentioned hermetically sealing constitution is substantially equal to the back-substrate-1-side hermetically sealing structure. However, in the face-substrate-2-side hermetically sealing structure, it is unnecessary to hermetically seal the video signal lines 8 and the scanning signal lines 9 and hence, the penetrating direction length of the sealing region is the substantially equal over the whole periphery of the frame 3 and, further, the penetrating direction length is set to a value equal to or less than the length LDK of the first sealing region 51 thus reducing the use quantity of the sealing material 5.

That is, a penetrating direction length (sealing width) LDA of a face-substrate-2-side third sealing region 53 facing the back-substrate-1-side first sealing region 51 and a penetrating direction length (sealing width) LSA of a face-substrate-2-side fourth sealing region 54 facing the back-substrate-1-side second sealing region 52 are set to substantially the same size and, at the same time, these lengths LDA and LSA are set to a value less than the length LDK of the first sealing region 51.

In this embodiment 1, by changing the penetrating direction length of the sealing region into which the lines penetrate corresponding to the thickness of the lines, it is possible to prevent the leaking of vacuum from being generated thus obtaining the highly reliable image display device which can possess a prolonged lifetime.

Further, on the face substrate 2 side on which the leaking of vacuum is hardly generated compared to the back substrate 1 side, the length of the sealing region may be shortened (narrowed) thus enhancing the operability and, at the same time, suppressing the generation of the damage to the lines and the like due to the flow of the sealing material.

### Embodiment 2

FIG. 6 is a schematic cross-sectional view of another embodiment of the image display device of the present invention and corresponds to FIG. 4, wherein parts which are identical with the parts described in FIG. 6 are given the same symbols. In FIG. 6, as described above, the frame body 3 is formed of, for example, a frit glass sintered body, a glass plate or the like, and the frame body 3 is formed by a single body or by a combination of a plurality of members and is formed in a substantially rectangular frame shape.

In the frame body 3, a thickness TDK of a pair of frame body members 31 which are arranged on the long side of the substantially-rectangular-shaped frame body 3 and a thickness TSK of a pair of frame body members 32 which are arranged on short side of the substantially-rectangular-shaped frame body 3 are set to a same size. That is, by establishing the relationship TDK=TSK, the thickness of the frame body 3 is set to the substantially same size over the whole periphery of the frame 3.

On the other hand, with respect to the penetrating direction length (width) of the sealing region, the length LDK of the first sealing region 51 into which the video signal lines 8 penetrate is set to a value less than the penetrating direction length LSK of the second sealing region 52 into which the scanning signal lines 9 having a larger thickness than the video signal lines 8 penetrate. Further, other constitutions of this embodiment are equal to the corresponding constitutions of the embodiment 1.

Due to the constitution of the embodiment 2, in addition to the acquisition of the excellent manner of operation and advantageous effects substantially equal to the manner of operation and advantageous effects of the embodiment 1, it is possible to enhance a mechanical strength of the frame body and, further, the frame body can be easily acquired.

### Embodiment 3

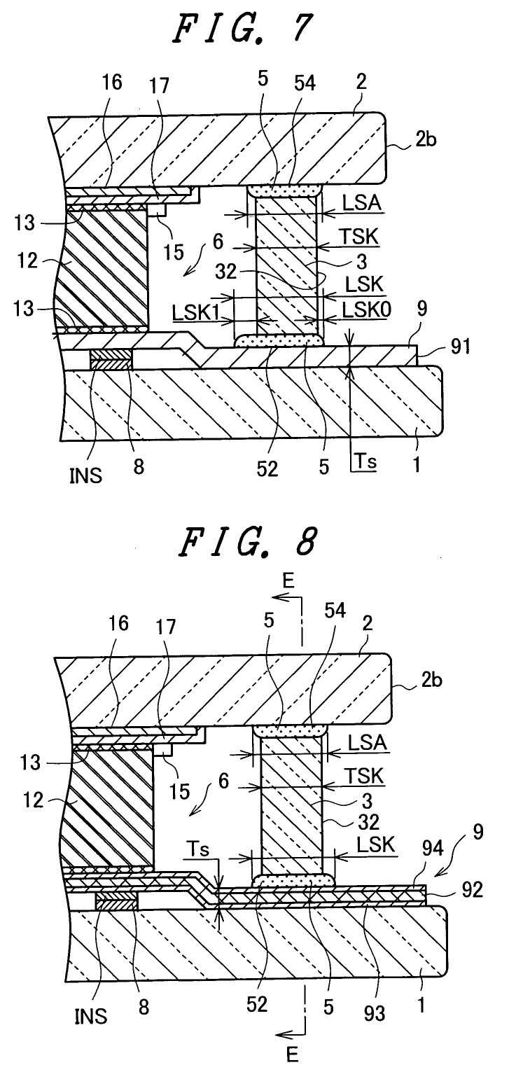

FIG. 7 is a schematic cross-sectional view of still another embodiment of the image display device of the present invention and corresponds to FIG. 3 described above, wherein parts which are identical with the parts described in FIG. 7 are given the same symbols. In FIG. 7, the center of the penetrating direction length of the second sealing region 52 into which the scanning lines 9 hermetically penetrate is offset from the center of the thickness direction of the frame body 3.

In the above-mentioned constitution, the penetrating direction length LSK of the second sealing region 52 is set to a size which is obtained by synthesizing three portions, that is, a length LSKI which is arranged inside the panel, a thickness TSK of the frame body 3 and a length LSKO which is arranged outside the frame body 3 and, at the same time, the length LSKI which is arranged inside the panel is set larger than the length LSKO which is arranged outside the frame body 3. Further, other constitutions are substantially equal to the corresponding constitutions of the embodiment 1.

Due to the constitution of the embodiment 3, the manner of operation and advantageous effects substantially equal to the manner of operation and advantageous effects of the embodiment 1, 2 can be obtained and, at the same time, it is possible to obtain an advantageous effect that an large or wide engaging space of the line lead terminal and an outer circuit not shown in the drawings can be ensured.

### Embodiment 4

FIG. 8 is a schematic cross-sectional view of still further embodiment of the image display device of the present invention and corresponds to FIG. 3 described above, wherein parts which are identical with the parts described in FIG. 8 are given the same symbols. In FIG. 8, the scanning lines 9 have the stacked structure constituted of three layers.

In the above-mentioned constitution, a low-resistance material, for example, a Cu material is used as a material of a core member 92, a Cr material having high adhesion property to a glass substrate is used as a material of a lower layer 93 which is brought into contact with the substrate 1, for example, and a Cr material having an oxidation preventing function is used as a material of a face-substrate-2-side upper layer 94, for example, wherein the upper layer 94 covers the core member 92 thus forming the three-layer stacked structure. Although it is preferable that the three-layer stacked structure is formed over the whole length of the image display device as a matter of course, the three-layer stacked structure may be constituted partially. Further, thicknesses of the core member 92, the lower layer 93 and the upper layer 94 may be suitably determined. Further, other constitutions of this embodiment are substantially equal to the corresponding constitutions of the embodiment 1.

Due to the constitution of the embodiment 4, the generation of the leaking of vacuum can be prevented by suppressing the generation of the stress on lines in the sealing region, and the voltage drop can be suppressed thus obtaining the highly reliable image display device which can possess a prolonged lifetime.

### Embodiment 5

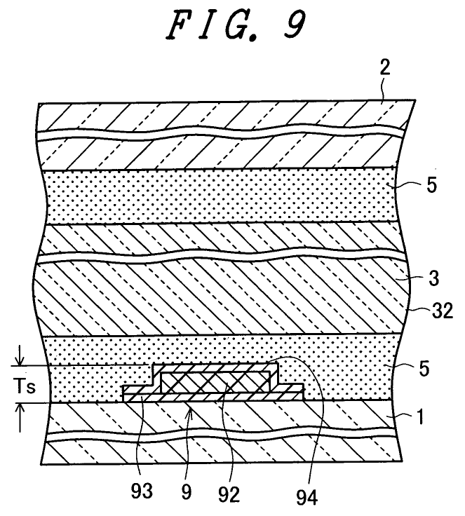

FIG. 9 is a schematic cross-sectional view of still another embodiment of the image display device of the present invention taken along a line E-E in FIG. 8, wherein parts which are identical with the parts described in FIG. 9 are given the same symbols.

In FIG. 9, the scanning signal lines 9 are formed in the three-layer stacked structure and, at the same time, the upper layer 94 covers the core member 92 ranging from an upper surface to a side surface of the core member 92, and the core member 92 is hermetically sealed by the upper layer 94 and the lower layer 93.

Due to the constitution of the embodiment 5, it is possible to prevent the sealing material from intruding into interlayers defined between the core member 92 and the upper and lower layers 94, 93.

The intrusion of the sealing material into the interlayers is frequently occurs in a step in which the substrate surface is pressed in the vertical direction at the time of sealing both substrates 1, 2 and the support body 3. Accordingly, by hermetically sealing the core member 92 and the upper and lower layers 94, 93, it is possible to prevent the intrusion of the sealing material.

In this manner, the generation of the leaking of vacuum can be prevented by suppressing the generation of the line stress in the sealing region, and the voltage drop can be suppressed thus obtaining the highly reliable image display device which can possess a prolonged lifetime.

The above-mentioned embodiment is explained in more detail. In the constitution described in the embodiment 4, by setting the sealing region lengths such that LDK: 5 mm, LSK: 8 mm, LSA=LDA: 5 mm in a state that Al lines having TDK: 5 mm, TSK: 8 mm and Td: 0.5 μm and Cr/Cu/Cr lines having Ts: of 3 μm are used, it is possible to reduce the generation of the leaking of vacuum thus obtaining the highly reliable image display device which can possess a prolonged lifetime compared to the conventional constitution in which the penetrating direction lengths in the sealing region are set equal to each other, that is, LDK=LSK=LSA=LDA.

Next, in the constitution described in the embodiment 2, by setting the sealing region lengths such that LDK: 5 mm, LSK: 10 mm, LSA=LDA: 5 mm in a state that the frame body 3 having the thickness of TDK=TSK:5 mm, Al lines having Td:0.5 μm, and Cr/Cu/Cr lines having Ts: of 3 μm are used, it is possible to reduce the generation of the leaking of vacuum thus obtaining the highly reliable image display device which can possess a prolonged lifetime compared to the conventional constitution in which penetrating direction lengths in the sealing region are set equal to each other, that is, LDK=LSK=LSA=LDA.

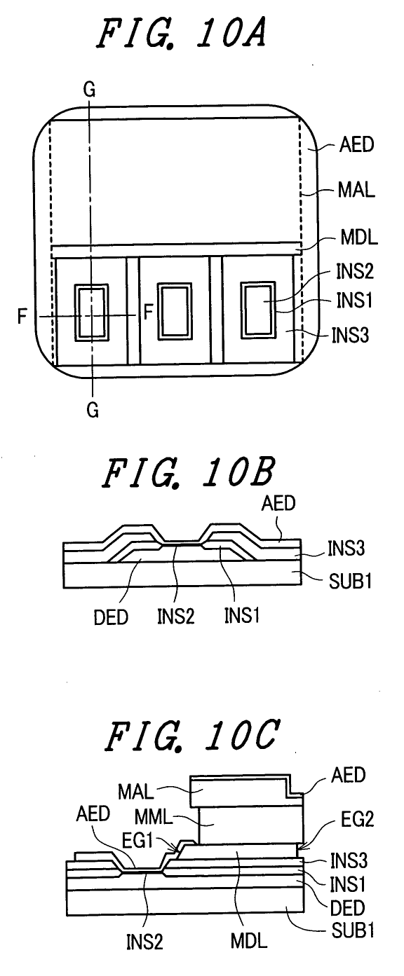

FIG. 10A, FIG. 10B and FIG. 10C are views for explaining one example of electron sources 10 which constitutes pixels of the image display device of the present invention, wherein FIG. 10A is a plan view, FIG. 10B is a cross-sectional view taken along a line F-F in FIG. 1A, and FIG. 10C is a cross-sectional view taken along a line G-G in FIG. 10A. The electron sources are formed of an MIM electron source.

The structure of the electron source is explained in conjunction with manufacturing steps. First of all, on the back substrate SUB1, lower electrodes DED (the video signal lines 8 in the above-mentioned respective embodiments), a protective insulation layer INS1, an insulation layer INS2 are formed. Next, an interlayer film INS3, upper bus electrodes AED (the scanning signal lines 9 in the above-mentioned respective embodiments) which become electricity supply lines to upper electrodes AED, and a metal film which constitutes a spacer electrode for arranging spacers 12 are formed by a sputtering method and the like, for example. Although the lower electrodes and the upper electrodes are made of aluminum, these electrodes are made of other metal described later.

The interlayer film INS3 may be made of silicon oxide, silicon nitride film, silicon or the like, for example. Here, the interlayer film INS3 is made of silicon nitride film and has a film thickness of 100 nm. The interlayer film INS3, when a pin hole is formed in a protective insulation layer INS1 formed by anodizing, fills a void and plays a role of ensuring the insulation between a lower electrode DED and an upper bus electrode (a three-layered laminated film which sandwiches Cu which constitutes a metal film intermediate layer MML between a metal film lower layer MDL and a metal film upper layer MAL) which constitutes the scanning signal electrode.

Here, the upper bus electrode AED is not limited to the above-mentioned three-layer laminated film and the number of layers may be increased more. For example, the metal film lower layer MDL and the metal film upper layer MAL may be made of a metal material having high oxidation resistance such as aluminum (Al), chromium (Cr), tungsten (W), molybdenum (Mo) or the like, an alloy containing such metal, or a laminated film of these metals. Here, the metal film lower layer MDL and the metal film upper layer MAL are made of an alloy of Al—Nd. In addition to the alloy, with the use of a five-layered film in which the metal film lower layer MDL is a laminated film formed of an Al alloy and Cr, W, MO or the like, the metal film upper layer MAL is a laminated film formed of Cr, W, Mo or the like and an Al alloy, and films which are brought into contact with the metal film intermediate layer MML made of Cu are made of a high-melting-point metal, in a heating step of a manufacturing process of the image display device, the high-melting-point metal functions as a barrier film thus preventing Al and Cu from being alloyed whereby the five-layered film is particularly effective in the reduction of resistance.

When the metal film lower layer MDL and the metal film upper layer MAL are made of only Al—Nd alloy, a film thickness of the Al—Nd alloy in the metal film upper layer MAL is larger than a film thickness of the Al—Nd alloy in the metal film lower layer MDL, and a thickness of The metal film intermediate layer MML made of Cu is made as large as possible to reduce the wiring resistance. Here, the film thickness of the metal film lower layer MDL is set to 300 nm, the film thickness of the metal film intermediate layer MML is set to 4 μm, and the film thickness of the metal film upper layer MAL is set to 450 nm. Here, Cu in the metal film intermediate layer MML can be formed by electrolytic plating or the like in addition to sputtering.

With respect to the above-mentioned five-layered film which uses high-melting-point metal, in the same manner as Cu, it is particularly effective to use a laminated film which sandwiches Cu with Mo which can be etched by wet etching, particularly, in a mixed aqueous solution of phosphoric acid, acetic acid and nitric acid as the metal film intermediate layer MML. In this case, a film thickness of Mo which sandwiches Cu is set to 50 nm, a film thickness of the Al alloy of the metal film lower layer MDL which sandwiches the metal film intermediate layer MML together with the metal film upper layer MAL is set to 300 nm, and the film thickness of the Al alloy of the metal film upper layer MAL which sandwiches the metal film intermediate layer MML together with the metal film lower layer MDL is set to 50 nm.

Subsequently, the metal film upper layer MAL is formed in a stripe shape which intersects the lower electrode DED by performing the patterning of resist by screen printing and etching. In performing the etching, for example, a mixed aqueous solution of phosphoric acid and acetic acid is used for wet etching. By excluding the nitric acid from the etchant, it is possible to selectively etch only the Al—Nd alloy without etching Cu.

Also in case of the five-layered film which uses Mo, by excluding the nitric acid from the etchant, it is possible to selectively etch only the Al—Nd alloy without etching Mo and Cu. Here, although one metal film upper layer MAL is formed per one pixel, two metal film upper layers MAL may be formed per pixel.

Subsequently, by using the same resist film directly or using the Al—Nd alloy of the metal film upper layer MAL as a mask, The metal film intermediate layer MML made of Cu is etched by wet etching using a mixed aqueous solution of phosphoric acid, acetic acid and nitric acid, for example. Since an etching speed of Cu in the etchant made of mixed aqueous solution of phosphoric acid, acetic acid and nitric acid is sufficiently fast compared to an etching speed of the Al—Nd alloy, it is possible to selectively etch only The metal film intermediate layer MML made of Cu. Also in case of the five-layered film which uses Mo, the etching speeds of Mo and Cu are sufficiently fast compared to an etching speed of the Al—Nd alloy and hence, it is possible to selectively etch only the three-layered film made of Mo and Cu. In etching Cu, in addition to the above-mentioned aqueous solution, an ammonium persulfate aqueous solution, a sodium persulfate solution can be effectively used.

Subsequently, the metal film lower layer MDL is formed in a stripe shape which intersects the lower electrode DED by performing the patterning of resist by screen printing and etching. The etching is performed by wet etching using a mixed aqueous solution of phosphoric acid and acetic acid. Here, by displacing the position of the printing resist film from the stripe electrode of the metal film upper layer MAL in the parallel direction, one-side EG1 of the metal film lower layer MDL projects from the metal film upper layer MAL thus forming a contact portion to ensure the connection with the upper electrode AED in a later stage. Accordingly, on the opposite side EG2 of the metal film lower layer MDL, using the metal film upper layer MAL and the metal film intermediate layer MML as masks, the over-etching is performed and hence, a retracting portion is formed on the metal film intermediate layer MML as if eaves are formed.

Due to the eaves of the metal film intermediate layer MML, the upper electrode AED which is formed as a film in a later step is separated. Here, since the film thickness of the metal film upper layer MAL is set larger than the film thickness of the metal film lower layer MDL, even when the etching of the metal film lower layer MDL is finished, it is possible to allow the metal film upper layer MAL to remain on the metal film intermediate layer MML made of Cu. Due to such a constitution, it is possible to protect a surface of Cu with the metal film upper layer MAL and hence, it is possible to ensure the oxidation resistance even when Cu is used. Further, it is possible to separate the upper electrode AED in a self-aligning manner and it is possible to form the upper bus electrodes which constitute scanning signal lines which perform the supply of electricity. Further, in case that the metal film intermediate layer MML is formed of the five-layered film which sandwiches Cu with Mo, even when the Al alloy of the metal film upper layer MAL is thin, Mo suppresses the oxidation of Cu and hence, it is not always necessary to make the film thickness of the metal film upper layer MAL larger than the film thickness of the metal film lower layer MDL.

Subsequently, electron emitting portions are formed as openings in the interlayer film INS3. The electron emitting portion is formed in a portion of an intersecting portion of a space which is sandwiched by one lower electrode DED inside the pixel and two upper bus electrodes (a laminated film consisting of a metal film lower layer MDL, a metal film intermediate layer MML, a metal film upper layer MAL and a laminated film consisting of a metal film lower layer MDL, a metal film intermediate layer MML, a metal film upper layer MAL of a neighboring pixel not shown in the drawing) which intersect the lower electrode DED. The etching is performed by dry etching which uses an etching gas containing CF₄ and SF₆ as main components, for example.

Finally, the upper electrode AED is formed as a film. The upper electrode AED is formed by a sputtering method. The upper electrode AED may be made of aluminum or a laminated film made of Ir, Pt and Au, wherein a film thickness may be 6 nm, for example. Here, the upper electrode AED is, at one portion (right side in FIG. 10C) of two upper bus electrodes (a laminated film consisting of a metal film lower layer MDL, a metal film intermediate layer MML and a metal film upper layer MAL) which sandwich the electron emitting portions, cut by a retracting portion (EG2) of the metal film lower layer MDL formed by the eaves structure of the metal film intermediate layer MML and the metal film upper layer MAL. Then, at another portion (left side in FIG. 10C) of the upper bus electrodes, the upper electrode AED is formed and is connected with the upper bus electrode (the laminated film consisting of the metal film lower layer MDL, the metal film intermediate layer MML and the metal film upper layer MAL) by a contact portion (EG1) of the metal film lower layer MDL without causing a disconnection thus providing the structure which supplies electricity to the electron emitting portions.

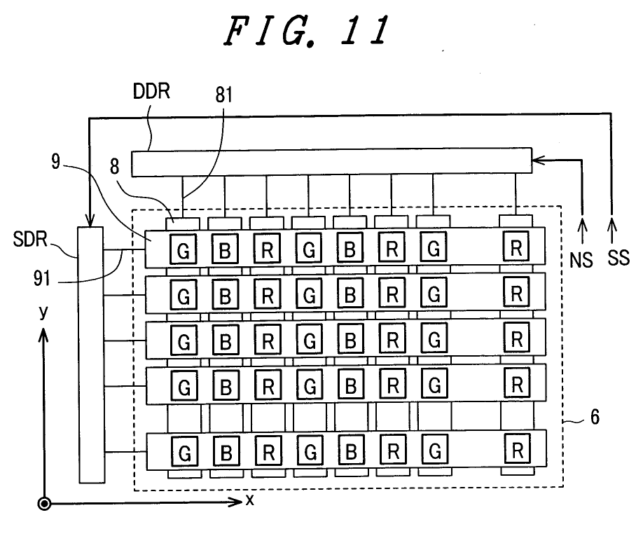

FIG. 11 is an explanatory view of an example of an equivalent circuit of an image display device to which the constitution of the present invention is applied. A region depicted by a broken line in FIG. 11 indicates a display region 6. In the display region 6, n pieces of video signal lines 8 and m pieces of scanning signal lines 9 are arranged in a state that these lines intersect each other thus forming matrix of n×m. Sub pixels are formed over the respective intersecting portions of the matrix and one group consisting of three unit pixels (or sub pixels) “R”, “G”, “B” in the drawing constitutes one color pixel. Here, the constitution of the electron sources is omitted from the drawing. The video signal lines (cathode lines) 8 are connected to the video signal drive circuit DDR through the video signal line lead terminals 81, while the scanning signal lines (gate lines) 9 are connected to the scanning signal drive circuit SDR through the scanning signal line lead terminal 91. The video signal NS is inputted to the video signal drive circuit DDR from an external signal source, while the scanning signal SS is inputted to the scanning signal drive circuit SDR in the same manner.

Due to such a constitution, by supplying the video signal to the video signal lines 8 which intersect the scanning signal lines 9 which are sequentially selected, it is possible to display a two-dimensional full color image. With the use of the display panel having this constitution, it is possible to realize the image display device at a relatively low voltage with high efficiency.

In the above-mentioned respective embodiments, the length LSK of the second sealing region 52 into which the scanning lines 9 hermetically penetrate is larger than the length LDK of the first sealing region 51 into which the thin-film image signal lines 8 hermetically penetrate and hence, it is possible to suppress the decrease of the degree of vacuum. When the thickness of the image signal lines 8 is larger than the thickness of the scanning signal lines 9, the length LDK of the first sealing region 51 may be set larger than the length LSK of the second sealing region 52.

What is claimed is:

1. An image display device comprising:
a back substrate which includes a plurality of first lines which extend in the first direction and are arranged in parallel in the second direction which intersects the first direction, an insulation film which is formed in a state that the insulation film covers the first lines, a plurality of second lines which extend in the second direction and are arranged in parallel in the first direction, and electron sources which are connected to the first lines and the second lines;
a face substrate which includes phosphor layers of a plurality of colors which emit light due to excitation thereof by electrons emitted from the electron sources and an anode, the face substrate facing the back substrate with a predetermined distance therebetween;
a frame body which surrounds a display region between the back substrate and the face substrate and holds the predetermined distance;
a panel which includes a sealing material which hermetically seals end surfaces of the frame body to the face substrate and the back substrate respectively and evacuate air in a space surrounded by the back substrate, the face substrate and the frame body, wherein
the image display device includes a first sealing region in which a sealing material which extends in the second direction is arranged on the plurality of first lines and a second region in which a sealing material which extends in the first direction is arranged on the plurality of second lines, and
a first-direction width of the first sealing region and a second-direction width of the second sealing region differ from each other.

2. An image display device according to claim 1, wherein the frame body differs in thickness thereof between the first sealing region and the second sealing region.

3. An image display device according to claim 1, wherein at portion of the sealing region formed between the frame body and the back substrate, a length of a sealing region portion arranged inside the panel differs from a length of the sealing region portion arranged outside the panel.

4. An image display device according to claim 1, wherein the first lines and the second lines differ from each other in thickness thereof inside the sealing region.

5. An image display device according to claim 1, wherein at least either one of the first lines and the second lines have line portions thereof which are arranged inside the panel and in the sealing region formed into the stacked structure.

6. An image display device according to claim 5, wherein the stacked structure includes a combination of materials which differ from each other in conductivity.

7. An image display device according to claim 1, wherein the first lines are video signal lines.

8. An image display device according to claim 1, wherein the second lines are scanning signal lines.

9. An image display device according to claim 1, wherein the electron source is formed of a thin-film-type electron emitting source which includes a lower electrode, an upper electrode and an electron acceleration layer which is sandwiched between the lower electrode and the upper electrode, and emits electrons from the upper electrode when a voltage is applied between the lower electrode and the upper electrode.

10. An image display device according to claim 1, wherein the electron source is constituted of an electron emitting element which includes a conductive film having an electron emitting portion.

11. An image display device according to claim 1, wherein the electron source is formed of carbon nanotubes.
